(19) United States
(12) Patent Application Publication
(10) Pub. No.: US 2001/0021924 A1
(43) Pub. Date: Sep. 13, 2001

(54) Electronic commerce system, electronic commerce method, storage media storing electronic, commerce program and electronic commerce program

(75) Inventor: Takeo Ohno, Tokyo (JP)

Correspondence Address: Davis A. Blumenthal, FOLEY & LARDNER, Washington Harbour, 3000 K Street, N.W., Suit 500, Washington, DC, 20007-5109, US

(73) Assignee: NEC CORPORATION

(21) Appl. No.: 09/798,979

(22) Filed: Mar. 6, 2001

(30) Foreign Application Priority Data
Mar. 7, 2000 (JP) 2000-062145

(51) Int. Cl. G06F 17/60

(52) U.S. Cl. 705/37

(57) ABSTRACT

An electronic commerce system is provided with a purchaser client used by a purchaser who wants to buy a commodity via the network; a seller client used by a seller who sells the commodity via the network; a commodity information providing server for storing commodity information including a commodity name and a commodity price of the commodity at least and for providing the commodity information which is stored to the purchaser client in response to a request from the purchaser client in the network; and a commercial transaction support server for relating to the commodity information providing server and for supporting a commercial transaction process between the purchaser client and the seller client via the network.

### BACKGROUND OF THE INVENTION

1. Field of the Invention

The present invention relates to an electronic commerce system, an electronic commerce method, a storage media for storing an electronic commerce program and an electronic commerce program for conducting commercial transactions between a seller and a purchaser via a network.

The present application claims priority of Japanese Patent Application No. 2000-062145 filed on Mar. 7, 2000, which is hereby incorporated by reference.

2. Description of Related Art

Recently, electronic commerce (electronic commercial transactions) using a network such as the Internet has been widely used rapidly in the world. The electronic commerce is that a purchaser accesses a seller's homepage, views commodity information and buys a commodity (such as described in Japanese Patent Application Laid-open No. Hei 11-250155).

The electronic commerce may be divided broadly into three techniques as described later.

In a first technique, as shown in FIG. 21, a seller X and a seller Y are respectively provided with a seller X exclusive commercial transaction server 101₁ and a seller Y exclusive commercial transaction server 101₂ and have commercial transactions with a purchaser A and purchaser B via the seller X exclusive commercial transaction server 101₁ and the seller Y exclusive commercial transaction server 101₂. The seller X exclusive commercial transaction server 101₁ and the seller Y exclusive commercial transaction server 101₂ accept commodity information registration from a seller client 102₁ of a seller X and a seller client 102₂ of a seller Y, provide commodity information in accordance with sight requests from a purchaser client 103₁ of a purchaser A and a purchaser client 103₂ of a purchaser B, and then manage processes of commercial transactions among the seller client 102₁, the seller client 102₂, the purchaser client 103₁ and the purchaser client 103₂, such as an order process, an order received process, a charge process and a payment process.

In a second technique, as shown in FIG. 22, a purchaser A and a purchaser B are respectively provided with a purchaser A exclusive commercial transaction server 104₁ and a purchaser B exclusive commercial transaction server 104₂, and the purchaser A, the purchaser B, a seller X and a seller Y have commercial transactions via the purchaser A exclusive commodity transaction server 104₁ and the purchaser B exclusive commodity transaction server 104₂.

In a third technique, as shown in FIG. 23, a purchaser A, a purchaser B, a seller A and a seller B are provided with a common commodity transaction server 105, and have commercial transactions using the common commodity transaction server 105.

However, in the first technique, each seller has an exclusive commercial transaction server, and therefore, though various presentations can be executed by providing commodity information, there are problems in that standardization of commercial transactions since owners of commodity transaction servers are different, and particularly in that users must deal with different interface (such as a display screen and an operation) whenever a seller changes. Also, for the seller, there is a problem in that a cost for making up, maintaining and managing a commodity transaction server increases.

Also, in the second technique, though it is possible for a purchaser to execute commercial transactions using a standardized interface, there is a problem in that flexibility of presentation is limited for a seller. Also, there is another problem in that it costs and it is troublesome since the seller must register commodity information in each commodity transaction server for each purchaser, must deal with each interface of each purchaser, and must be skilled in each interface.

Furthermore, in the third technique, though it is possible for both of a purchaser and a seller to have commercial transactions using a standardized interface, there is a problem in that freedom of presentation is limited by design of a common commodity transaction server for the seller.

### SUMMARY OF THE INVENTION

In view of the above, it is an object of the present invention to provide an electronic commerce system, an electronic commerce method, a storage media for storing electronic commerce program and an electronic commerce program in which both of a purchaser and a seller can have commercial transactions using a standardized interface and the seller can execute presentation of commodities freely.

According to a first aspect of the present invention, there is provided an electronic commerce system including:

a purchaser client for connecting a purchaser with a network, the purchaser who wants to buy a commodity via the network;

a seller client for connecting a seller with the network, the seller who sells the commodity via the network;

a commodity information providing server for storing commodity information including a commodity name and a commodity price of the commodity at least and for providing the commodity information which is stored to the purchaser client in response to a request from the purchaser client in the network; and

a commercial transaction support server for relating to the commodity information providing server and for supporting a commercial transaction process between the purchaser client and the seller client via the network.

In the foregoing, a preferable mode is one wherein the commodity information providing server is used by only the seller client which is specified.

Also, a preferable mode is one wherein the commercial transaction support server is commonly used by a plurality of the purchaser clients and a plurality of the seller clients.

Also, a preferable mode is one wherein the commodity information providing server is exclusively used by each of the seller clients and the commercial transaction support server is commonly used by the plurality of the purchaser clients and the plurality of the seller clients.

Also, a preferable mode is one wherein when the commodity information providing server receives commodity selection information generated by a commodity selection operation by the purchaser who wants to buy the commodity from the purchaser client, the commodity information providing server transmits the commodity selection information to the commercial transaction support server, and when the commercial transaction support server receives the commodity selection information from the commodity information providing server, the commercial transaction support server executes an order process in response to the commodity selection information.

Also, a preferable mode is one wherein the commercial transaction support server receives the commodity selection information from the commodity information providing server, the commercial transaction support server transmits a corresponding order form to the purchaser client in response to the commodity selection information.

Also, a preferable mode is one wherein when the commodity information providing server provides commodity information of a predetermined commodity to the purchaser client, the commodity information providing server transmits the commodity information to the commercial transaction support server while including selection information corresponding to a detailed design of the commodity, and when the commercial information providing server receives the commodity selection information including the detailed design of the commodity set by the purchaser from the purchaser client, the commodity information providing server transmits the commodity selection information to the commercial transaction support server.

Also, a preferable mode is one wherein when the commodity information providing server provides commodity information of the predetermined commodity to the purchaser client, the commodity information providing server transmits the commodity information to the commercial transaction support server while including selection information corresponding to the detailed design of the commodity, when the commercial information providing server receives the commodity selection information including the detailed design of the commodity set by the purchaser from the purchaser client, the commodity information providing server transmits commodity identification information corresponding to the commodity selection information to the commercial transaction support server, and when the commercial transaction support server receives the commodity identification information from the commodity information providing server, the commercial transaction support server executes an order process in response to the commodity identification information.

Furthermore, a preferable mode is one wherein the purchaser client includes a display section for displaying the commodity information and commercial transaction management information given from the commodity information providing server and the commercial transaction support server together with an operation button and an instruction input section for instruction-inputting the operation button displayed on the display section, and wherein the operation button includes a commodity selection button in which the commodity selection information is generated by instruction-inputting with the instruction input section.

According to a second aspect of the present invention, there is provided an electronic commerce method using a network, including:

a commodity information providing step, when there is a sight request from a purchaser who wants to buy a commodity via the network, of providing commodity information including a commodity name and a commodity price of the commodity at least to a purchaser client which gives the sight request to a commodity information providing server; and

a commercial transaction support step, when the purchaser who wants to buy the commodity gives a predetermined notification to the commodity information providing server, of supporting commercial transactions between the purchaser client and a seller client via the network by a commercial transaction support server.

In the foregoing, a preferable mode is one wherein each of the seller client exclusively uses a corresponding commodity information providing server and the seller client and the purchaser client commonly use the commercial transaction support server.

According to a third aspect of the present invention, there is provided a storage medium for storing an electronic commerce program using a network, the electronic commerce program caused to carry out a computer to perform processes, including:

a commodity information providing process, when there is a sight request from a purchaser who wants to buy a commodity via the network, of providing commodity information including a commodity name and a commodity price of the commodity at least to a purchaser client which gives the sight request to a commodity information providing server; and

a commercial transaction support process, when the purchaser who wants to buy the commodity gives a predetermined notification to the commodity information providing server, of supporting commercial transactions between the purchaser client and a seller client via the network by a commercial transaction support server.

In the foregoing, a preferable mode is one wherein each of the seller client exclusively uses a corresponding commodity information providing server and the seller client and the purchaser client commonly use the commercial transaction support server.

According to a fourth aspect of the present invention, there is provided an electronic commerce program using a network, the electronic commerce program caused to carry out a computer to perform processes, including:

a commodity information providing process, when there is a sight request from a purchaser who wants to buy a commodity via the network, of providing commodity information including a commodity name and a commodity price of the commodity at least to a purchaser client which gives the sight request to a commodity information providing server; and

a commercial transaction support process, when the purchaser who wants to buy the commodity gives a predetermined notification to the commodity information providing server, of supporting commercial transactions between the purchaser client and a seller client via the network by a commercial transaction support server.

In the foregoing, a preferable mode is one wherein each of the seller client exclusively uses a corresponding commodity information providing server and the seller client and the purchaser client commonly use the commercial transaction support server.

With this configuration, since the commodity information providing server for having a commodity information providing function and the commercial transaction support server for having a predetermined commercial transaction management function and for supporting the commercial transaction process are separated and related to each other, for example, an exclusive commodity information providing server is corresponded to each seller client and the commercial transaction support server is commonly used between each purchaser client and each seller client, and thereby it is possible for both the purchaser and the seller to execute commercial transactions using a standardized interface, it is possible for the seller to execute presentation of the commodity freely and it is possible to execute commercial transactions at low cost.

In other words, it is possible for the seller to determine a display screen design and a commodity presentation design freely based on an original idea so as to promote sales and it is possible for the seller to produce, to change, to update the display screen and a like easily. Also, the seller becomes a member of a service provider who is an owner of the commercial transaction support server and receives commercial transaction support service, and thereby it is possible for the seller to emphasize presentation of the commodity more and it is possible to reduce a commercial transaction cost.

Also, it is possible for the purchaser to determine whether an order is issued or not smoothly while viewing presentation of various commodities.

Also, it is possible for the purchaser and the seller to execute regular commercial transactions after an order process using a same operation while viewing a same format regardless of others simply and smoothly. As this effect becomes more remarkable, logic becomes more complex since a number of purchaser clients and a number of seller clients increase.

Furthermore, the commercial support server for executing comparative regular processes is commonly used, and thereby it is possible to increase a fault tolerance for preventing occurrences of a server going down and program error; and provides security for keeping information confidential.

### BRIEF DESCRIPTION OF THE DRAWINGS

The above and other objects, advantages, and features of the present invention will be more apparent from the following description taken in conjunction with the accompanying drawings in which:

FIG. 1 is a block diagram showing a configuration of an electronic commerce system according to a first embodiment of the present invention;

FIG. 2 is a block diagram explaining the configuration of the electronic commerce system according to the first embodiment of the present invention;

FIG. 3 is a block diagram further explaining the configuration of the electronic commerce system according to the first embodiment of the present invention;

FIG. 4 is a block diagram showing a configuration of a purchaser client and a seller client in the electronic commerce system according to the first embodiment of the present invention;

FIG. 5 is a block diagram showing a configuration of a commodity sight server and a commercial transaction support server in the electronic commerce system according to the first embodiment of the present invention;

FIG. 6 is a block diagram explaining a electronic commerce method using the electronic commerce system according to the first embodiment of the present invention;

FIG. 7 is a flowchart explaining an operation of the purchaser client according to the first embodiment of the present invention;

FIG. 8 is a flowchart explaining an operation of the commodity sight sever according to the first embodiment of the present invention;

FIG. 9 is a flowchart explaining an operation of the commercial transaction support server according to the first embodiment of the present invention;

FIG. 10 is a flowchart explaining an operation of the seller client according to the first embodiment of the present invention;

FIG. 11 is a view showing an example of a commodity sight screen displayed on a display section in the purchaser client according to the first embodiment of the present invention;

FIG. 12 is a view showing an example of a commodity selection screen displayed on the display section in the purchaser client according to the first embodiment of the present invention;

FIG. 13 is a view showing an example of an order confirmation page screen displayed on the display section in the purchaser client according to the first embodiment of the present invention;

FIG. 14 is a view showing an example of a receiving order process displayed on the display section in the seller client according to the first embodiment of the present invention;

FIG. 15 is a view showing an example of an order confirmation page screen displayed on the display section in the purchaser client according to the first embodiment of the present invention;

FIG. 16 is a view showing an example of a receiving order process displayed on a display section in the seller client according to the first embodiment of the present invention;

FIG. 17 is a block diagram showing a configuration of an electronic commerce system according to a second embodiment of the present invention;

FIG. 18 is a flowchart explaining an operation of a purchaser client in the electronic commerce system according to the second embodiment of the present invention;

FIG. 19 is a flowchart explaining an operation of a commodity sight sever in the electronic commerce system according to the second embodiment of the present invention;

FIG. 20 is a flowchart explaining an operation of a commercial transaction support server in the electronic commerce system according to the second embodiment of the present invention;

FIG. 21 is a block diagram explaining a conventional technique;

FIG. 22 is a block diagram explaining another conventional technique; and

FIG. 23 is a block diagram explaining still another conventional technique.

### DETAILED DESCRIPTION OF THE PREFERRED EMBODIMENTS

Best modes for carrying out the present invention will be described in further detail using various embodiments with reference to the accompanying drawings.

### First Embodiment

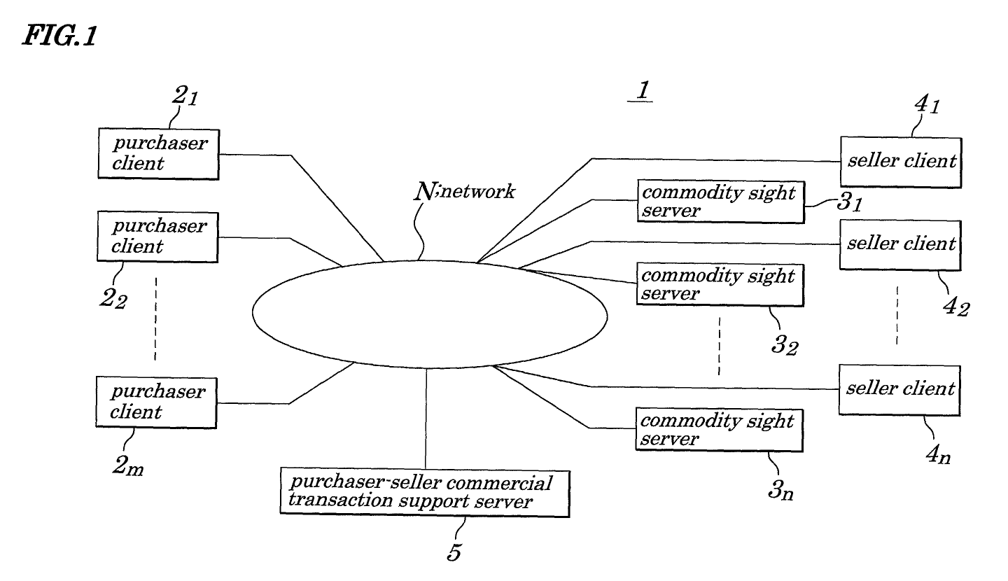

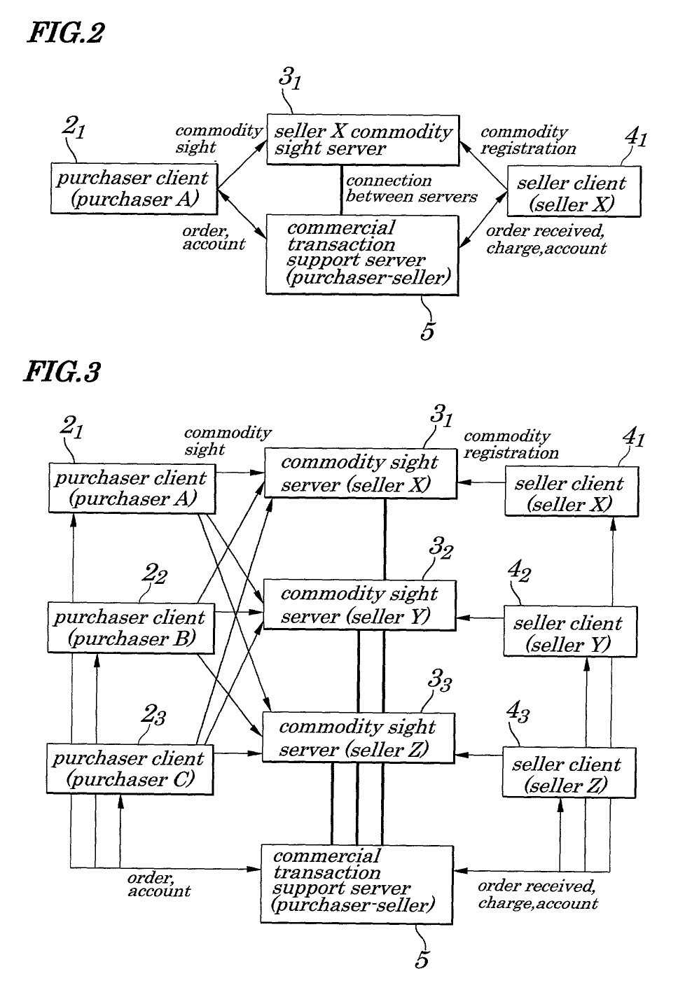

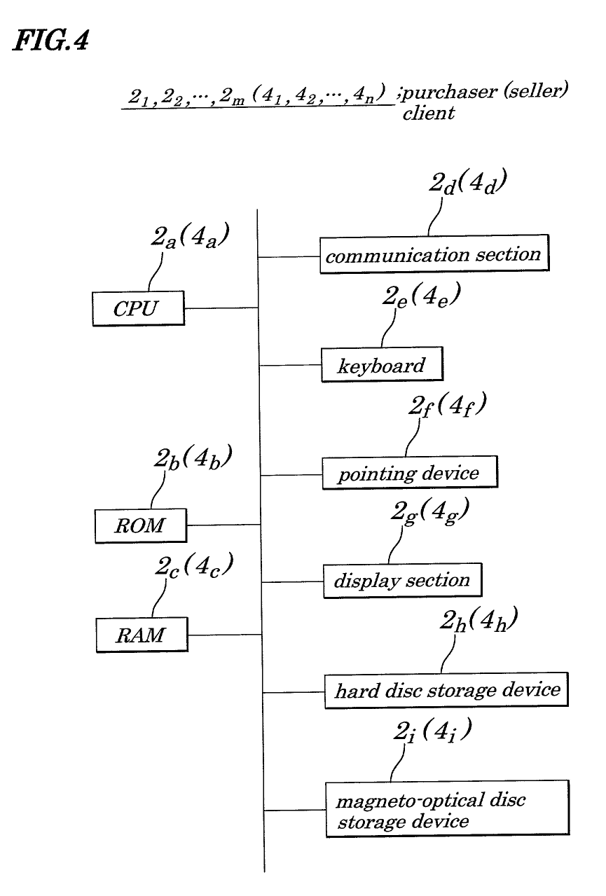

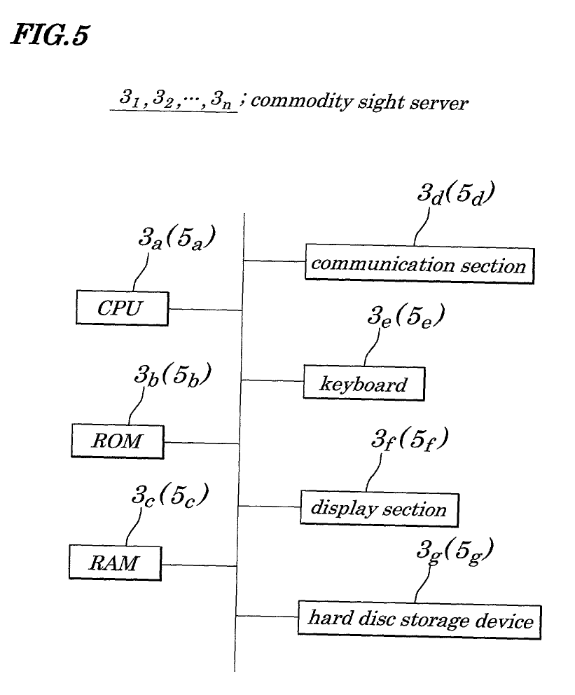

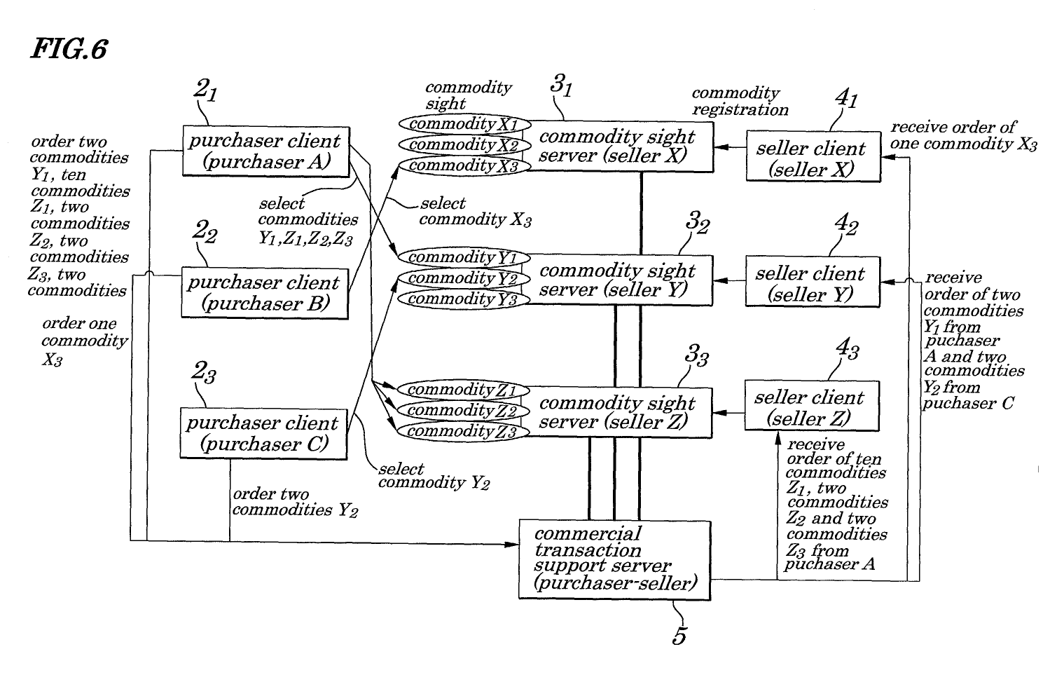

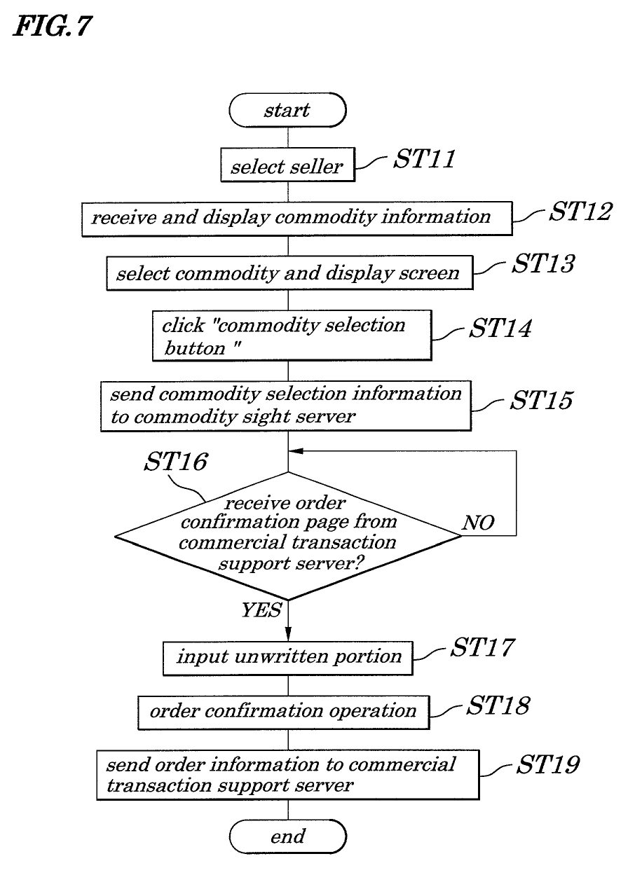

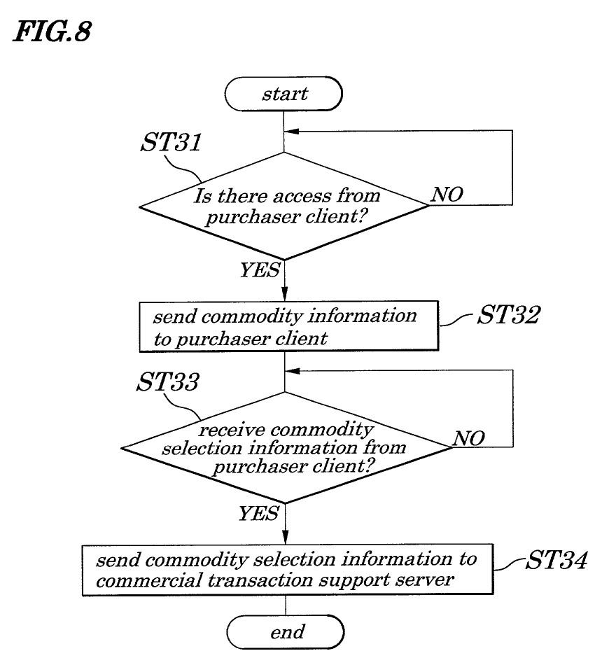

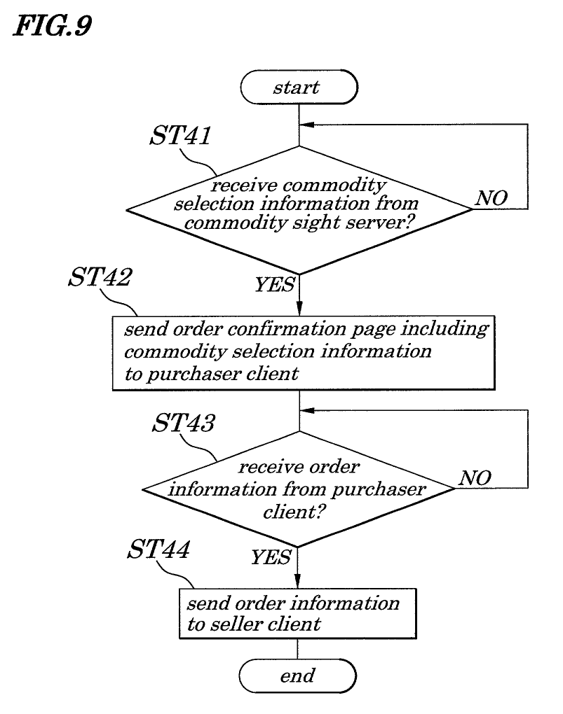

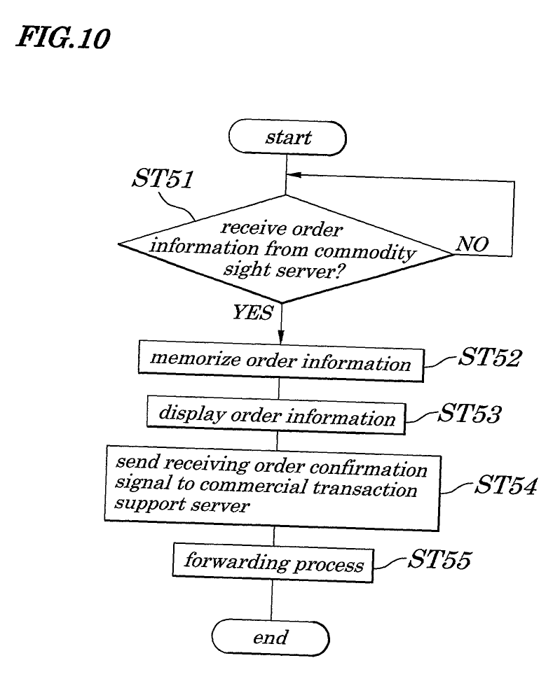

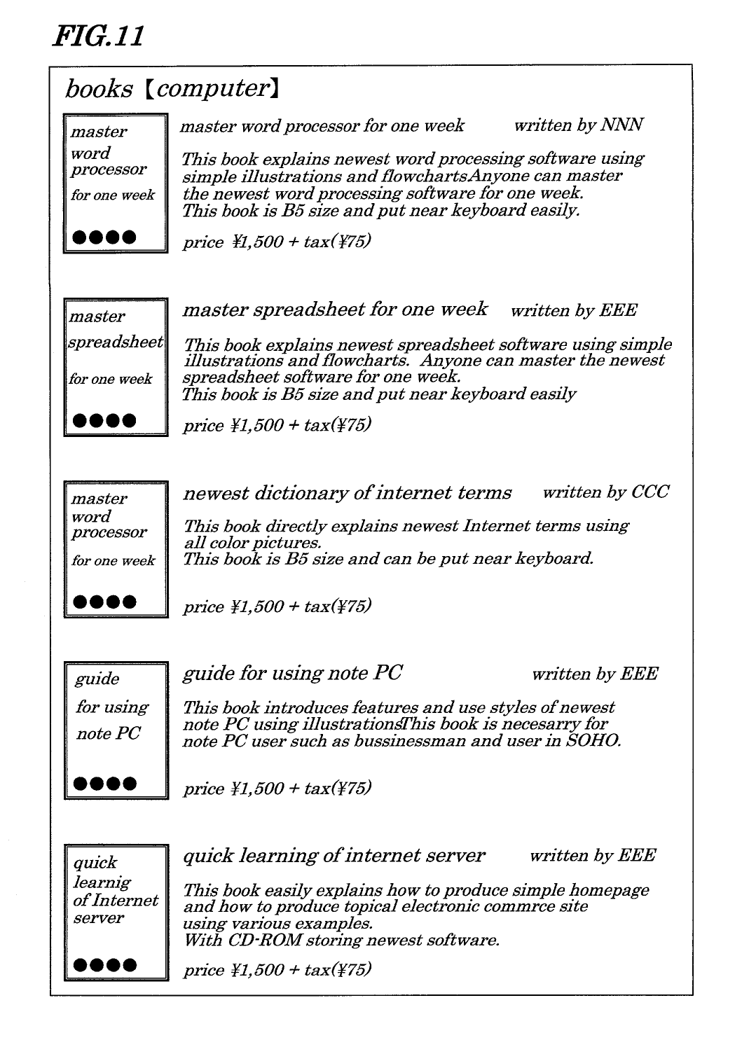

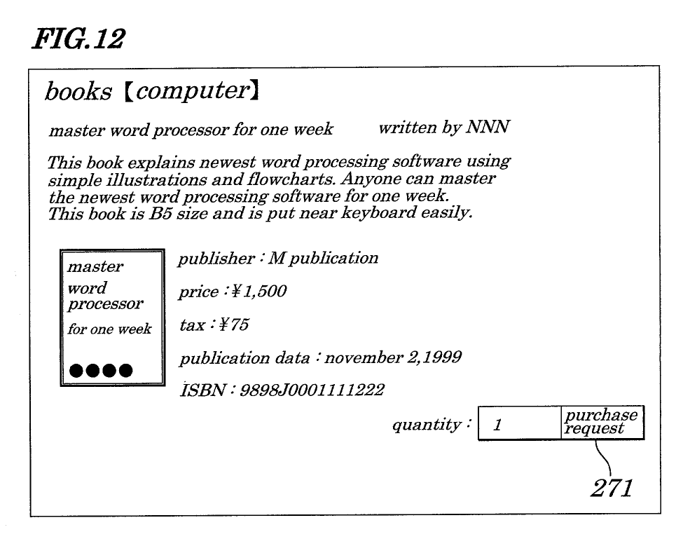

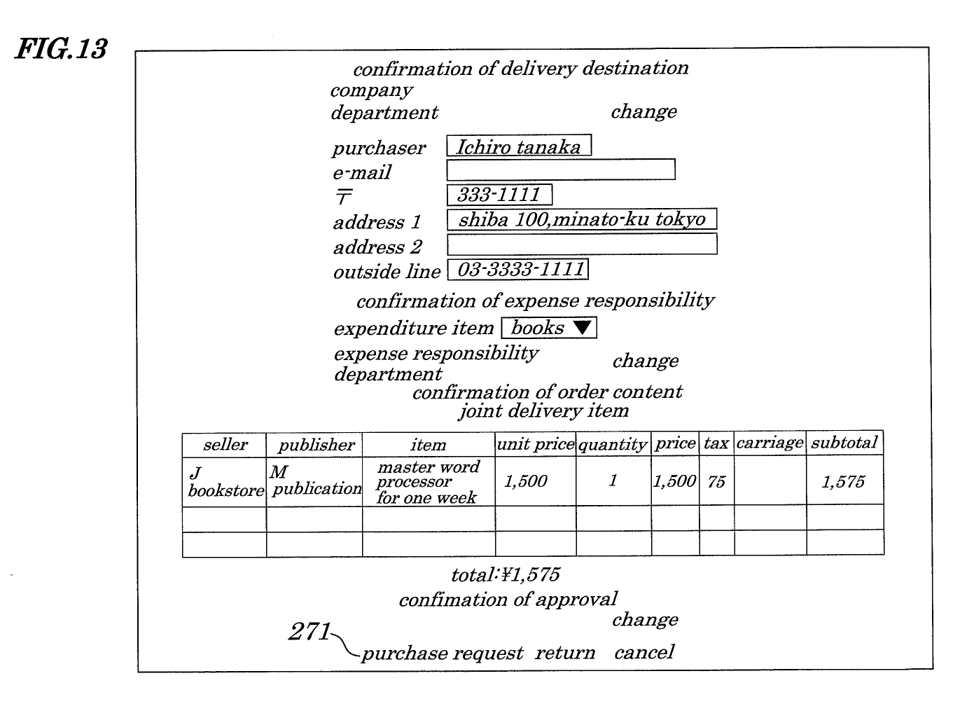

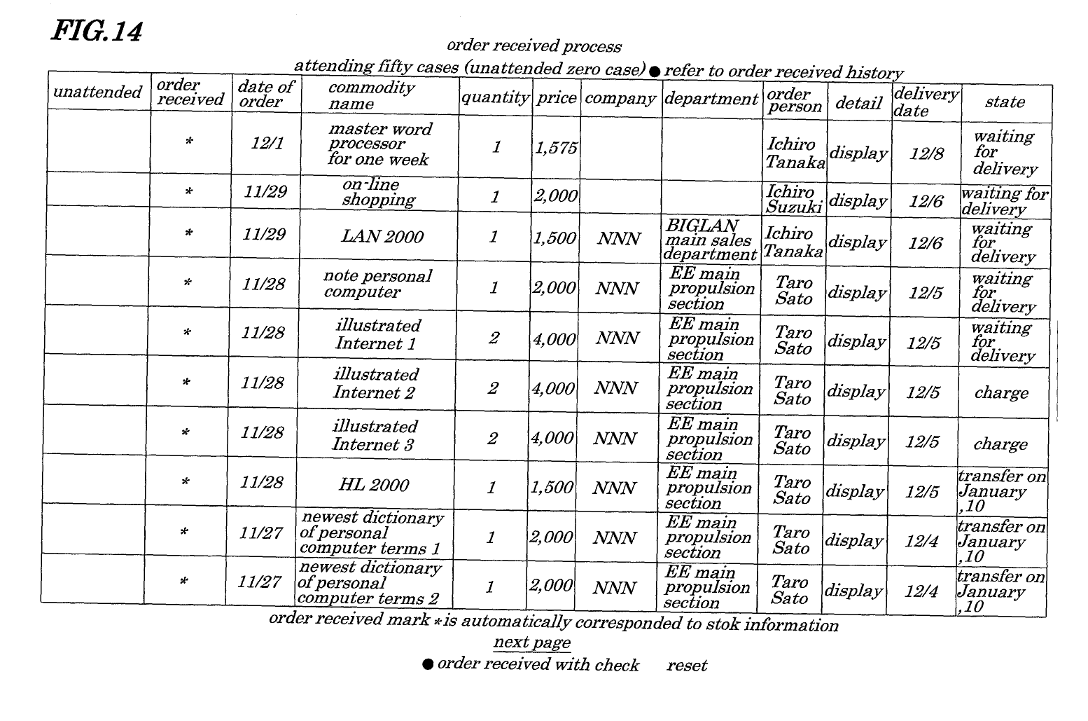

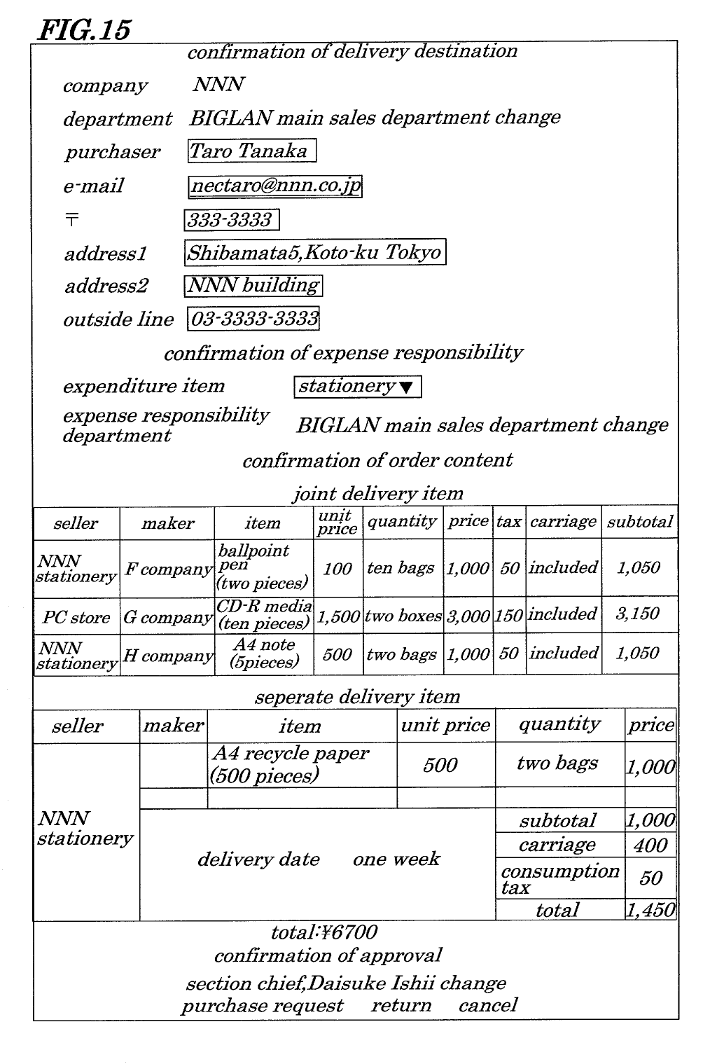

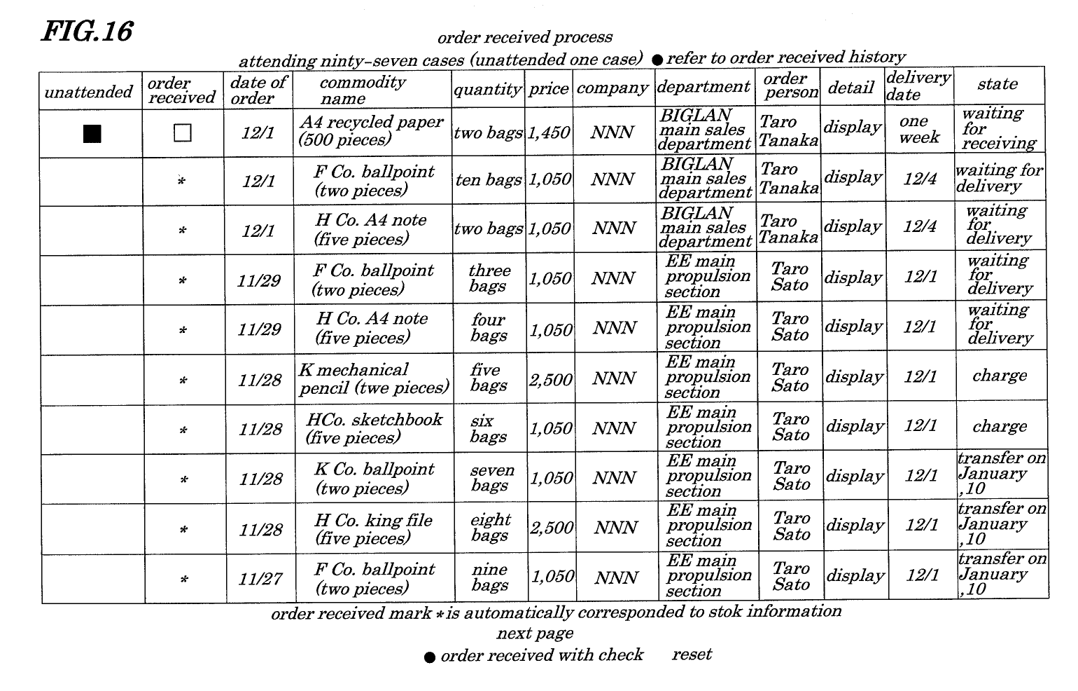

FIG. 1 is a block diagram showing a configuration of an electronic commerce system according to a first embodiment of the present invention, FIG. 2 and FIG. 3 are block diagrams explaining the configuration of the electronic commerce system, FIG. 4 is a block diagram showing a configuration of a purchaser client and a seller client in the electronic commerce system, FIG. 5 is a block diagram showing a configuration of a commodity sight server and a commercial transaction support server in the electronic commerce system, FIG. 6 is a block diagram explaining a electronic commerce method using the electronic commerce system, FIG. 7 is a flowchart explaining an operation of the purchaser client, FIG. 8 is a flowchart explaining an operation of the commodity sight sever, FIG. 9 is a flowchart explaining an operation of the commercial transaction support server, FIG. 10 is a flowchart explaining an operation of the seller client, FIG. 11 is a view showing an example of a commodity sight screen displayed on a display section in the purchaser client, FIG. 12 is a view showing an example of a commodity selection screen displayed on the display section in the purchaser client, FIG. 13 is a view showing an example of an order confirming page screen displayed on the display section in the purchaser client, FIG. 14 is a view showing an example of a receiving order process displayed on a display section in the seller client, FIG. 15 is a view showing an example of an order confirming page screen displayed on the display section in the purchaser client and FIG. 16 is a view showing an example of a receiving order process displayed on the display section in the seller client.

AN electronic commerce system 1, as shown in FIG. 1, is provided with a plurality of purchaser client 2₁ to purchaser client 2ₘ (where m is a natural number) used to see commodity information and to order by purchasers and connecting the purchasers and a network N, a plurality of commodity sight server (commodity information providing sever) 3₁ to commodity sight server (commodity information providing sever) 3ₙ (where n is a natural number) respectively used by a plurality of sellers and providing pre-registered commodity information to the purchaser client 2₁ to purchaser client 2ₘ via the network N in accordance with a request, a plurality of seller client 4₁ to seller client 4ₙ used to confirm an order received and to execute a charge process by sellers and a commercial transaction support server 5 shared by the purchasers and the sellers and supporting a commercial transaction process such as an order process, an order received process, a charge process and an account process executed between each purchaser and each seller via the network N in connection with the commodity sight server 3₁ to commodity server 3ₘ.

In the electronic commerce system 1, both of one-to-one commercial transactions between a purchaser A and a seller X as shown in FIG. 2 and multi-to-multi commercial transactions between a plurality of a purchaser A, a purchaser B and a purchaser C and a plurality of a seller X, a seller Y and a seller Z as shown in FIG. 3 can be smoothly processed in connection with commodity sight server 3₁ to commodity sight server 3ₙ exclusively used by sellers and the common commercial transaction support server 5.

Purchaser A, purchaser B . . . and seller X, seller Y . . . become members of a service provider having the commercial transaction support server 5 and providing commercial transaction services, and thereby receive the commercial transaction services so as to execute commercial transactions between members. The seller X (Y, Z . . . ) has the purchaser client 2₁ (2₂, 2₃ . . . ) and the commodity sight server 3₁ (3₂, 3₃ . . . ) and entrusts management of the commercial transactions after the order process to the service provider in principle.

The purchaser client 2₁ (2₂, 2₃ . . . 2ₘ) as shown in FIG. 4, is provided with a CPU (Central Processing Unit) 2a for controlling each section in accordance with a predetermined program, a ROM (Read Only Memory) 2b for storing a control program performed by the CPU 2a, a RAM (Random Access Memory) 2c used as a work area, a communication section 2d for data communicating between commodity sight server 3₁ to commodity sight server 3ₙ and the commercial transaction support server 5 connected to the network N, a keyboard 2e used to input data required for order or like, a pointing device (an instruction input section) 2f such as a mouse, a display section 2g for displaying a commodity sight screen, for example, a CRT (Cathode Ray Tube), a hard disc storage device 2h for storing predetermined data and a predetermined program and a magneto-optical disc storage device 2i for storing predetermined data and a predetermined program.

The commodity sight server 3₁ (3₂, 3₃ . . . 3ₙ), as shown in FIG. 5, is provided with a CPU 3a for controlling each section in accordance with a predetermined control program, a ROM 3b for storing a control program performed by the CPU 3a, a RAM 3c used as a work area of the CPU 3a, a communication section 3d for data communicating between purchaser client 2₁ to purchaser client 2ₙ or seller client 4₁ to seller client 4ₙ and the commercial transaction support server 5 connected to the network N, a keyboard 3e, a display section 3f and a hard disc storage device 3g for storing predetermined data and a predetermined process program.

In the hard disc storage device 3g, data such as original commodity information of each seller and various process programs such as a commodity information providing process program for transmitting predetermined commodity information of a commodity seller to the purchaser client 2₁ (2₂, 2₃ . . . 2ₙ) in response to a sight request from the purchaser client 2₁ (2₂, 2₃ . . . 2ₙ).

The commodity information is produced by the seller and then is updated when it is necessary (such as regularly once a week). Also, the commodity information is updated by operation in the commodity sight server 3₁ (3₂, 3₃ . . . 3ₙ) and also can be updated by operation in the seller client 4₁ (4₂, 4₃ . . . 4ₙ).

Also, the seller client 4₁ (4₂, 4₃ . . . 4ₙ) has a same configuration of the purchaser client 2₁ (2₂, 2₃ . . . 2ₙ) and, as shown in FIG. 4, is provided with a CPU 4a, a ROM 4b, a RAM 4c, a communication section 4d, a keyboard 4e, a pointing device 4f, a display section 4g, a hard disc storage device 4h and a magneto-optical disc storage device 4i.

Also, the commercial transaction support server 5 has a same configuration of the commodity sight server 3₁ (3₂, 3₃ . . . 3ₙ) and, as shown in FIG. 5, is provided with a CPU 5a, a ROM 5b, a RAM 5c, a communication section 5d, a keyboard 5e, a display section 5f and a hard disc storage device 5g.

In the hard disc storage device 5g, predetermined data and various process programs such as a commodity information providing process program for supporting commercial transactions between the seller client 4₁ (4₂, 4₃ . . . 4ₙ) and the purchaser client 2₁ (2₂, 2₃ . . . 2ₙ).

Next, an explanation will be given of an electronic commerce method using the electronic commerce with reference to FIG. 6 to FIG. 10.

In the first embodiment, as shown in FIG. 6, commercial transactions are executed approximately at a same time among a purchaser A, a purchaser B, a purchaser C, a seller X, a seller Y and a seller Z, the purchaser A orders a commodity Y₁ of the seller Y and a commodity Z₁, a commodity Z₂ and a commodity Z₃ of the seller Z, the purchaser B orders a commodity X₃ of the seller X and the purchaser C orders a commodity Y₃ of the seller Y.

Detailed explanations will be given of the electronic commerce method in a case in that the purchaser B orders a commodity X₃ of the seller X with reference to FIG. 7 to FIG. 10.

First, as shown in FIG. 7, the purchaser B operates the purchaser client 2₂ so as to start a browser and access a homepage of the seller X (Step ST11).

As shown in FIG. 8, the commodity sight server 3₁ in which commodity information of the seller X is previously registered waits until a member purchaser accesses (Step ST31). In this case, the commodity sight server 3 sends the commodity information to the purchaser client 2₂ via the network N (Step ST32).

With this operation, the purchaser client 2₂ receives commodity information, and then a commodity sight screen such as shown in FIG. 11 is displayed on the display section (Step ST12). The commodity sight screen shown in FIG. 11 is an example in which a predetermined bookstore (J bookstore) is selected as the seller X and a book is selected as the commodity X₃.

The purchaser B searches the commodity sight screen with reference to commodity images and explanation sentences. When the purchaser B searches a desired commodity, the purchaser B clicks the image using the pointing device 2f so as to select a predetermined commodity, and then, as shown in FIG. 12, a commodity selection screen in which detailed explanations of the commodity are given is displayed (Step ST13).

The purchaser B views contents of the commodity selection screen, and when the purchaser B wants to buy the commodity, the purchaser B inputs a quantity and clicks a commodity selection button 271 (Step ST14).

With this operation, the CPU 2a transmits commodity selection information including a selected commodity name and a selected quantity to the commodity sight server 3₁ via the network N (Step ST15).

As shown in FIG. 8, when the commodity sight sever 3₁ receives the commodity selection information from the commodity selection information from the purchaser client 2₂ (Step ST33), the commodity sight server 3₁ transmits the commodity selection information to the commercial transaction support server 5 via the network N (Step ST34).

As shown in FIG. 9, when the commercial transaction support server 5 receives the commodity selection information (Step ST41), the commercial transaction support server 5 writes the commodity selection information including the commodity name and the quantity in a predetermined order sheet, and then transmits the order sheet after adding required items as an order confirmation page which requires confirmation of the order contents to the purchaser client 3₂ (Step ST42).

As shown in FIG. 7, when the purchaser client 2₂ receives the order confirmation page (Step ST16), the CPU 2a displays the contents of the order confirmation page as shown in FIG. 13.

At this time, the purchaser B additionally inputs necessary items such as a delivery destination and payments (Step ST17), clicks a purchase request button 272 and thereby executes an order confirmation operation (Step ST18). With this operation, the CPU 2a transmits contents of the written order sheet to the commercial transaction support server 5 as order information (Step ST19).

As shown in FIG. 9, when the commercial transaction support server 5 receives the order information (Step ST43), the CPU 5a transmits the order information to the seller client 4₁ (Step ST44).

As shown in FIG. 10, when the seller client 4₁ receives order information (Step ST51), the CPU 4a stores the order information in the hard disc storage device 4h shown in FIG. 4 (Step ST52), and then displays an order receiving screen such as shown in FIG. 14 on the display section 4g together with order information from other purchasers (Step ST53).

Then, when the seller X confirms the order received, the CPU 4a transmits an order received confirmation signal to the commercial transaction server 5 (Step ST54) and moves to a forwarding process (Step ST55).

Then, the commercial transaction support server 5 manages a process state such as an acceptance process, a charge process and a payment process.

Also, orders from the purchaser A and the purchaser C are processed similarly to the above-described operation.

Similarly to the example of the purchaser A, in a case in that orders are given to the seller X and the seller Y and various commodities are ordered to a same seller, the commercial transaction support server 5 puts respective pieces of order information together so as to transmit the order information from the purchaser client 2₁. The purchaser client 2₁ displays an order confirmation page screen in a unified format so as to confirm contents together as shown in FIG. 15 and so as to be able to process orders together.

Also, the seller client 4₄ at a side of the seller Z, as shown in FIG. 16, displays a receiving order process screen so that order contents can be confirmed together.

As described above, in the first embodiment, commodity sight server 3₁ to commodity sight server 3ₙ and the commodity transaction support server 5 are separated and are related one another, each of seller client 4₁ to seller client 4ₙ is corresponded to each of exclusive commodity sight server 3₁ to exclusive commodity sight server 3ₙ, the commercial transaction support server 5 is commonly used by each of purchaser client 2₁ to purchaser client 2ₘ and each of seller client 4₁ to seller client 4ₘ, and therefore, it is possible for both of purchasers and sellers to execute commercial transactions using a standardized interface, it is possible for sellers to execute presentation of commodities and it is possible to execute commercial transactions at low cost.

In other words, it is possible for a seller to determine a display screen design and a commodity presentation way freely based on an original idea, to promote sales and to change and update the display screen and a like easily. Also, the seller becomes a member of a service provider who is an owner of the commercial transaction support server 5 and has commercial transaction services, and thereby it is possible to emphasize commodity presentation and it is possible to reduce costs for commercial transactions.

Also, it is possible for a purchaser to determine orders smoothly while receiving presentation of various commodities.

Also, it is possible for the seller and the purchaser to execute regular commercial transactions after the order process simply and smoothly by similar operations while viewing a display screen of a same format regardless of others. As this effect becomes remarkable as logic becomes complex caused by that purchasers and sellers are many and purchaser client 2₁ to purchaser client 2ₘ and seller client 4₁ to seller client 4ₙ increases.

Furthermore, the commercial transaction support server 5 which executes comparative regular processes is commonly used, and thereby it is possible to increase a fault tolerance for preventing occurrences of a server down and a program error, and a security for keeping secrecy of information.

### Second Embodiment

Next, a second embodiment according to the present invention will be described.

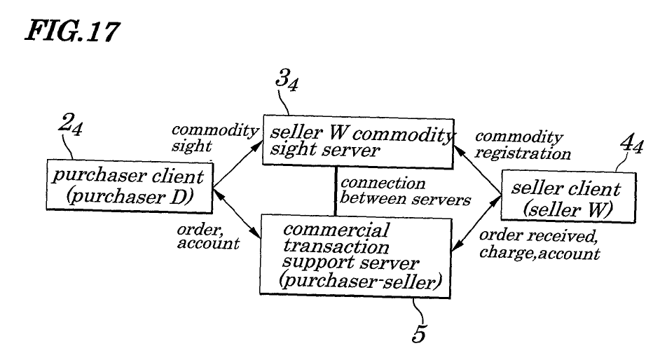

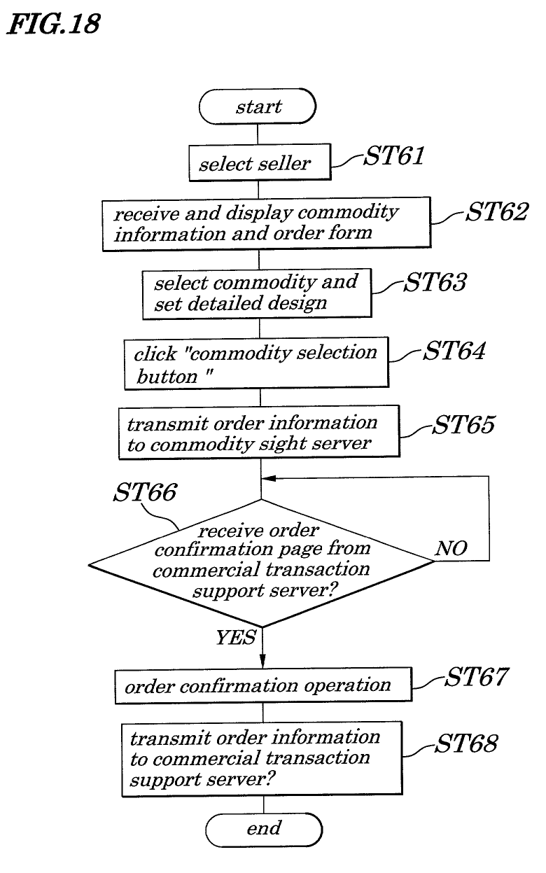

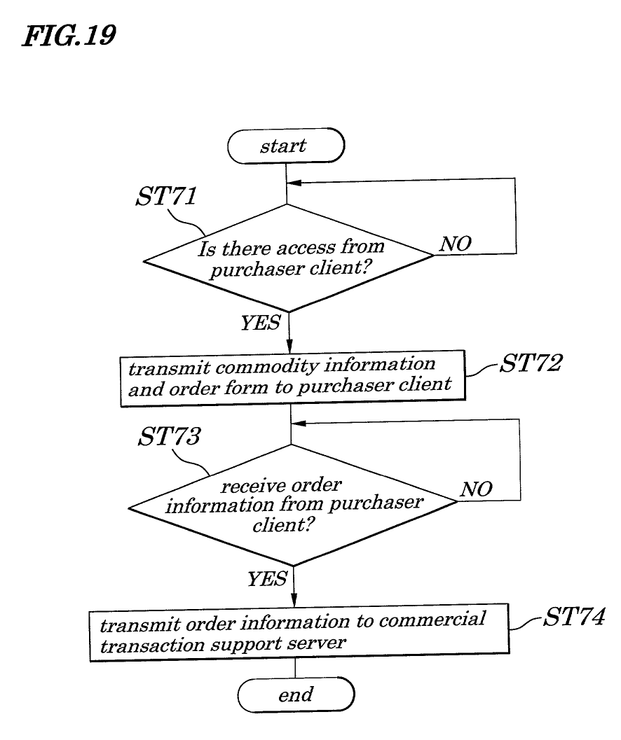

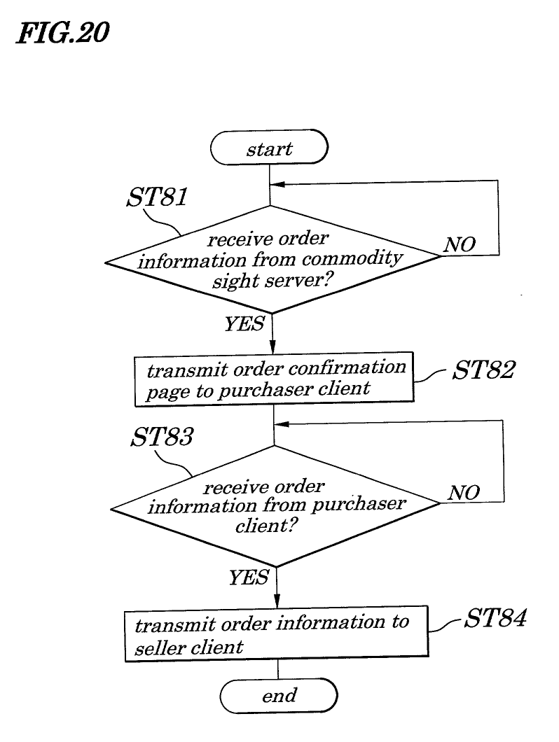

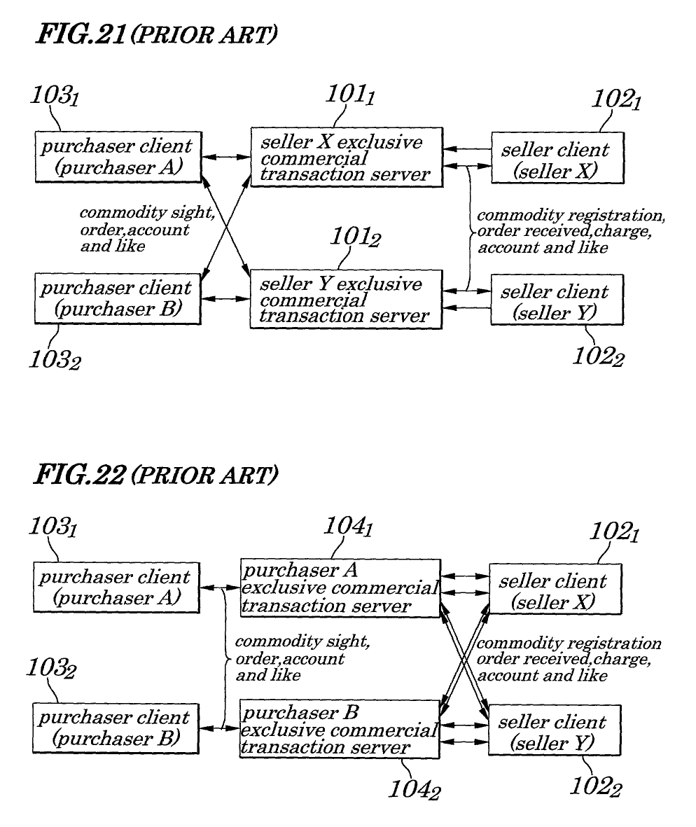

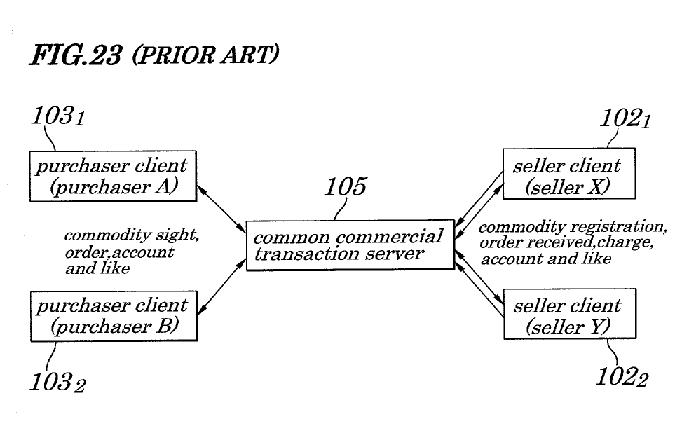

FIG. 17 is a block diagram showing a configuration of an electronic commerce system according to the second embodiment of the present invention, FIG. 18 is a flowchart explaining an operation of a purchaser client in the electronic commerce system, FIG. 19 is a flowchart explaining an operation of a commodity sight sever in the electronic commerce system and FIG. 20 is a flowchart explaining an operation of a commercial transaction server in the electronic commerce system.

Differences between the first embodiment and the second embodiment are that information of a detailed set design is transmitted in addition to commodity names and quantities, though only information of commodity names and quantities is transmitted from the purchaser client to the commodity sight server as a commodity selection server.

In the second embodiment, therefore, selection information corresponding to a detailed commodity design is also transmitted to the purchaser client as commodity information.

Therefore, the second embodiment can deal with a commodity which requires to select detailed items, such as a travel commodity.

Other elements are similar those of the first embodiment, and therefore, explanations thereof will be omitted.

Next, an electronic commerce method according to the second embodiment will be explained with reference to FIG. 17 to FIG. 20.

In the second embodiment, a purchaser D orders a travel service W1 from a seller W.

First, as shown in FIG. 18, in Step ST61, the purchaser D operates a purchaser client 2₄ so as to access a homepage of the seller W who sells travel services or a like.

The commodity sight server 3₄ in which commodity information of the seller is registered waits until a member accesses (Step ST71) as shown in FIG. 19. In this case, the commodity sight server 3₄ transmits its commodity information to the purchaser client 2₄ together with an order form including selection information corresponding to a detailed commodity design (Step ST72).

With this operation, the purchaser client 2₄ receives commodity information, and then a commodity sight screen is displayed on a display section 2g shown in FIG. 4 (Step ST62).

The purchaser D searches the commodity sight screen with reference to commodity images and explanation sentences. When the purchaser D finds a desired commodity, the purchaser D clicks the commodity image using a pointing device 2f shown in FIG. 4 or a like, and thereby selects a predetermined travel service so as to display a commodity selection screen in which a detailed explanation of the commodity is introduced. And then, the purchaser D clicks positions of a travel destination, a schedule, a price, an air line, a hotel, a dinner, an optional tour and a like so as to set a detailed plan (Step ST63).

When the purchaser D wants to buy the travel service of a selected plan, the purchaser D clicks a commodity selection button 271 (Step ST64).

With this operation, a CPU 2a shown in FIG. 4 transmits order information including a selected commodity name, a selected quantity and a selected detailed design to the commodity sight server 3₄ (Step ST65).

As shown in FIG. 19, when the commodity sight server 3₄ receives the order information from the purchaser client 2₄ (Step ST73), the commodity sight server 3₄ transmits the order information to the commercial transaction support server 5 (Step ST74).

As shown in FIG. 20, when the commercial transaction support server 5 receives the order information (Step ST81), the commercial transaction support server 5 transmits an order confirmation page which require confirmation of order contents to the purchaser client 2₄ (Step ST82).

When the purchaser client 2₄ receives the order confirmation page (Step ST66), the purchaser client 2₄ displays contents of the order confirmation page.

At this time, the purchaser D additionally inputs necessary items such as a delivery destination and a payment, clicks a purchase request button 272, and thereby executes an order confirmation operation (Step ST67). With this operation, the CPU 2a transmits contents of a written and confirmed order form to the commercial transaction support server 5 as order information (Step ST68).

When the commercial transaction support server 5 receives the order information (Step ST83), the commercial transaction support server 5 transmits the order information to a seller client 4₄ (Step ST84).

When the seller client 4₄ receives the order information, a CPU 4a stores the order information in a hard disc storage device 4h and displays an order received process screen on a display section 4g together with other purchasers' order information. Then, when the seller W confirms reception of an order, the CPU 4a transmits a receiving order confirmation signal to the commercial transaction support server 5 and moves to a forwarding process.

With the second embodiment, it is possible to obtain effects approximately similar to those of the first embodiment.

In addition to these effects, though a purchaser selects detailed designs such as a travel service, an employment agency or a SI service, it is possible to execute commercial transactions smoothly and surely.

It is thus apparent that the present invention is not limited to the above embodiments but may be changed and modified without departing from the scope and spirit of the invention.

For example, in the first embodiment or the second embodiment, each exclusive commodity sight server 3₁ (3₂, 3₃ . . . 3ₙ) is corresponded to each seller client 4₁ (4₂, 4₃ . . . 4ₙ), however, a commodity sight sever may be commonly used by some sellers who deal with similar commodities (including services).

Also, explanations are given of a case in that only the commercial transaction support server 5 executes the commercial transaction process in the first embodiment and the second embodiment, however, a plurality of commercial transaction support servers may be provided so that the commercial transactions are shared by functions after issuing an order.

Also, the network may be wired, wireless or a mixture of wired and wireless.

Also, when the commodity transaction support server 5 receives commodity selection information from the commodity server 3₁ (3₂, 3₃ . . . 3ₙ), the commodity transaction support server 5 may select an order sheet of a corresponding format and may transmit the order sheet to the purchaser client 2₁ (2₂, 2₃ . . . 2ₙ).

Furthermore, in the second embodiment, the commodity sight server 3₁ (3₂, 3₃ . . . 3ₙ) transmits order information of the travel service to the commodity transaction support server 5 in Step ST74, however, order information may be stored in a hard disc storage device 3g (FIG. 5), an ID number corresponding to order information may be transmitted to the commodity transaction support server 5 and the commodity transaction support server 5 may deal with the ID number similarly to the commodity name.

What is claimed is:

1. An electronic commerce system comprising:
a purchaser client for connecting a purchaser with a network, said purchaser who wants to buy a commodity via said network;
a seller client for connecting a seller with said network, said seller who sells said commodity via said network;
a commodity information providing server for storing commodity information including a commodity name and a commodity price of said commodity at least and for providing said commodity information which is stored to said purchaser client in response to a request from said purchaser client in said network; and
a commercial transaction support server for relating to said commodity information providing server and for supporting a commercial transaction process between said purchaser client and said seller client via said network.

2. The electronic commerce system according to claim 1, wherein said commodity information providing server is used by only said seller client which is specified.

3. The electronic commerce system according to claim 1, wherein said commercial transaction support server is commonly used by a plurality of said purchaser clients and a plurality of said seller clients.

4. The electronic commerce system according to claim 1, wherein said commodity information providing server is exclusively used by each of a plurality of said seller clients and said commercial transaction support server is commonly used by a plurality of said purchaser clients and said plurality of said seller clients.

5. The electronic commerce system according to claim 1, wherein when said commodity information providing server receives commodity selection information generated by a commodity selection operation by said purchaser who wants to buy said commodity from said purchaser client, said commodity information providing server transmits said commodity selection information to said commercial transaction support server, and when said commercial transaction support server receives said commodity selection information from said commodity information providing server, said commercial transaction support server executes an order process in response to said commodity selection information.

6. The electronic commerce system according to claim 5, wherein when said commercial transaction support server receives said commodity selection information from said commodity information providing server, said commercial transaction support server transmits a corresponding order form to said purchaser client in response to said commodity selection information.

7. The electronic commerce system according to claim 5, wherein when said commodity information providing server provides commodity information of a predetermined commodity to said purchaser client, said commodity information providing server transmits said commodity information to said commercial transaction support server while including selection information corresponding to a detailed design of said commodity, and when said commercial information providing server receives said commodity selection information including said detailed design of said commodity set by said purchaser from said purchaser client, said commodity information providing server transmits said commodity selection information to said commercial transaction support server.

8. The electronic commerce system according to claim 5, wherein when said commodity information providing server provides commodity information of a predetermined commodity to said purchaser client, said commodity information providing server transmits said commodity information to said commercial transaction support server while including selection information corresponding to a detailed design of said commodity, when said commercial information providing server receives said commodity selection information including said detailed design of said commodity set by said purchaser from said purchaser client, said commodity information providing server transmits commodity identification information corresponding to said commodity selection information to said commercial transaction support server, and when said commercial transaction support server receives said commodity identification information from said commodity information providing server, said commercial transaction support server executes an order process in response to said commodity identification information.

9. The electronic commerce system according to claim 5 wherein said purchaser client includes a display section for displaying said commodity information and commercial transaction management information given from said commodity information providing server and said commercial transaction support server together with an operation button and an instruction input section for instruction-inputting said operation button displayed on said display section, and wherein said operation button includes a commodity selection button in which said commodity selection information is generated by instruction-inputting with said instruction input section.

10. An electronic commerce method using a network, comprising:
a commodity information providing step, when there is a sight request from a purchaser who wants to buy a commodity via said network, of providing commodity information including a commodity name and a commodity price of said commodity at least to a purchaser client which gives said sight request to a commodity information providing server; and
a commercial transaction support step, when said purchaser who wants to buy said commodity gives a predetermined notification to said commodity information providing server, of supporting commercial transactions between said purchaser client and a seller client via said network by a commercial transaction support server.

11. The electronic commerce method according to claim 10, wherein each of a plurality of said seller clients exclusively uses a corresponding commodity information providing server and said plurality of said seller clients and a plurality of said purchaser clients commonly use said commercial transaction support server.

12. A storage medium storing an electronic commerce program used in an electronic commerce system with a network, said electronic commerce program to cause a computer to carry out:
a commodity information providing process, when there is a sight request from a purchaser who wants to buy a commodity via said network, of providing commodity information including a commodity name and a commodity price of said commodity at least to a purchaser client which gives said sight request to a commodity information providing server; and
a commercial transaction support process, when said purchaser who wants to buy said commodity gives a predetermined notification to said commodity information providing server, of supporting commercial transactions between said purchaser client and a seller client via said network by a commercial transaction support server.

13. The storage medium for storing an electronic commerce program according to claim 12, wherein each of plurality of said seller clients exclusively uses a corresponding commodity information providing server and said plurality of said seller clients and a plurality of said purchaser clients commonly use said commercial transaction support server.

14. An electronic commerce program used in an electronic commerce system with a network, said electronic commerce program to cause a computer to carry out:
a commodity information providing process, when there is a sight request from a purchaser who wants to buy a commodity via said network, of providing commodity information including a commodity name and a commodity price of said commodity at least to a purchaser client which gives said sight request to a commodity information providing server; and
a commercial transaction support process, when said purchaser who wants to buy said commodity gives a predetermined notification to said commodity information providing server, of supporting commercial transactions between said purchaser client and seller client via said network by a commercial transaction support server.

15. The electronic commerce program according to claim 14, wherein each of a plurality of said seller clients exclusively uses a corresponding commodity information providing server and said plurality of said seller clients and a plurality of said purchaser clients commonly use said commercial transaction support server.
